(19) United States
(12) Patent Application Publication
(10) Pub. No.: US 2012/0227706 A1
(43) Pub. Date: Sep. 13, 2012

(54) INTERNAL COMBUSTION ENGINE

(76) Inventors: Dai TANAKA, Okazaki-shi (JP); Kazuyoshi Nakane, Okazaki-shi (JP); Kimihiko Sato, Okazaki-shi (JP); Kyohei Yamaguchi, Nagoya-shi (JP)

(21) Appl. No.: 13/406,644

(22) Filed: Feb. 28, 2012

(30) Foreign Application Priority Data
Mar. 8, 2011 (JP) 2011-050803

(51) Int. Cl. F02D 41/30; F02M 69/00

(52) U.S. Cl. 123/445

(57) ABSTRACT

A fuel injection unit of an internal combustion engine includes at least an injector, an inlet opening, and an intake stroke injection device. A controller causes the intake stroke injection device to cause the injector to inject fuel in an intake stroke so that the fuel is introduced into an interior of a cylinder from the inlet opening. The fuel is injected from the injector into a range, which spreads in a width of an inside of the inlet opening when viewed from above of the cylinder, and which spreads in a width defined in a side of a center of the cylinder from a valve shaft in a state where the inlet valve is in a maximum lift-up level within the inside of the inlet opening when viewed from a lateral of the cylinder.

### BACKGROUND

The present invention is related to an internal combustion engine which can realize an improvement in performance by setting accurately the injecting condition under which fuel is injected into an air intake passage without providing directly in a cylinder a fuel injector which injects fuel directly into an interior of the cylinder.

As an internal combustion engine (an engine), there is known an engine which includes direct injectors which are positioned in a cylinder head so that fuel is directly injected into a combustion chamber or interior of each cylinder and a port injector which injects fuel in an air intake passage (refer to Patent Literature 1).

In the engine including the direct injectors and the port injector, by injecting fuel at a high pressure directly into an interior of the cylinder from the direct injector, a vaporization latent heat of fuel is made use of in cooling intake air so as to reduce the temperature of an air-fuel mixture to thereby suppress the generation of knocking. Further, the density of air can be enhanced by cooling the intake air, and therefore, the amount of air taken in at full load can be increased so as to improve the performance of the engine. Additionally, by injecting fuel into the air intake passage from the port injector, a homogenization of air-fuel mixture can be promoted in a low-load engine driving range in which the air-fuel mixture flow within the interior of the cylinder is weak and the homogenization of air-fuel mixture is deteriorated.

In the engine including the direct injectors and the port injector, however, a distal end of the direct injector mounted in the cylinder head is exposed to combustion gases of high temperatures and high pressures. Because of this, even in the case of fuel being injected from the port injector to promote the homogenization of air-fuel mixture, fuel needs to be kept injected from the direct injector to cool the distal end of the direct injector by a cooling effect of the fuel injected. Thus, in the current situations, fuel has to be injected not only from the port injector but also from the direct injector. Additionally, part of fuel injected from the direct injector collides with a wall of the combustion chamber and burns in the form of a film of liquid, leading to a problem that lots of particulate matters are discharged. Further, the direct injector needs to inject fuel at a high pressure, and therefore, there are fears that a power loss in a high-pressure pump affects the performance of the engine.

Resistances to heat and pressure are needed for the direct injector. Further, the distal end of the direct injector is exposed to combustion gases, and therefore, deposits tends to be accumulated thereon as a result of production of combustion products or carbonization of fuel depending upon driving conditions of the engine. Thus, countermeasures against the accumulation of deposits are necessary. Because of this, with the internal combustion engine with the direct injectors, there is caused a problem that costs incurred for the fuel injection shaft is increased.

[Patent Literature 1] JP-A-2009-228447

### SUMMARY

It is therefore one advantageous aspect of the present invention to provide an internal combustion engine which can maintain a performance resulting when fuel is directly injected into an interior of a cylinder so as to obtain a high performance by controlling accurately a fuel injecting conditions in an intake stroke without providing a direct injector which injects fuel directly into the interior of the cylinder.

According to one aspect of the invention, there is provided an internal combustion engine comprising:

a fuel injection unit including at least an injector which injects fuel from a fuel injection port into an air intake passage, an inlet opening communicating the air intake passage with an interior of a cylinder via a cylindrical portion, and an intake stroke injection device which causes the injector to inject fuel in an intake stroke; and

a controller which causes the intake stroke injection device to cause the injector to inject fuel in the intake stroke so that the fuel is introduced into the interior of the cylinder from the inlet opening so that an air-fuel mixture is formed in the interior of the cylinder, wherein

the fuel is injected from the injector into a range which, spreads in a width of an inside of the inlet opening when viewed from above of the cylinder, and which spreads in a width defined in a side of a center of the cylinder from a valve shaft in a state where the inlet valve is in a maximum lift-up level within the inside of the inlet opening when viewed from a lateral of the cylinder.

The fuel injected from the injector may spread, when viewed from the lateral of the cylinder, into a range defined between two intersection points, at which a line which extends along a lower surface of the air intake passage from a valve seat of the inlet valve when the inlet valve is in the maximum lift-up level and a line which extends along the lower surface of the air intake passage from a seat at the inlet opening respectively intersect with a boundary line between the cylindrical portion and the air intake passage.

The lower surface of the air intake passage may have a wall surface which extends straight towards the inlet opening.

The internal combustion engine may be configured such that: the air intake passage has an upper wall portion which extends straight towards the inlet opening, the fuel injection port of the injector is disposed so that an injecting direction of the fuel is parallel to the upper wall portion therealong, and intake air into the air intake passage is introduced towards the inlet opening from an opposite side to the inlet opening across the fuel injection port of the injector, so that the injecting direction of fuel and an introducing direction of intake air is parallel to each other.

The internal combustion engine may comprise a fuel pressure setting device for setting a fuel pressure in accordance with a revolving speed and load of the internal combustion engine, and the controller causes the fuel pressure setting device to increase the fuel pressure in a state in which the revolving speed of the internal combustion engine is in a predetermined range of the revolving speed.

### BRIEF DESCRIPTION OF DRAWINGS

FIG. 1 is a schematic block diagram showing the whole of an internal combustion engine according to an embodiment of the invention.

FIG. 2 is a block diagram showing a main part of FIG. 1.

FIG. 3 is a perspective view showing an external appearance of an inlet port.

FIG. 4 is a top plan view of the surroundings of the inlet port which depicts how fuel spreads.

FIG. 5 is a side view of the surroundings of the inlet port which depicts how fuel spreads.

FIG. 6 is a graph showing a relation between a revolving speed of the engine and a fuel pressure.

### DETAILED DESCRIPTION OF EXEMPLIFIED EMBODIMENTS

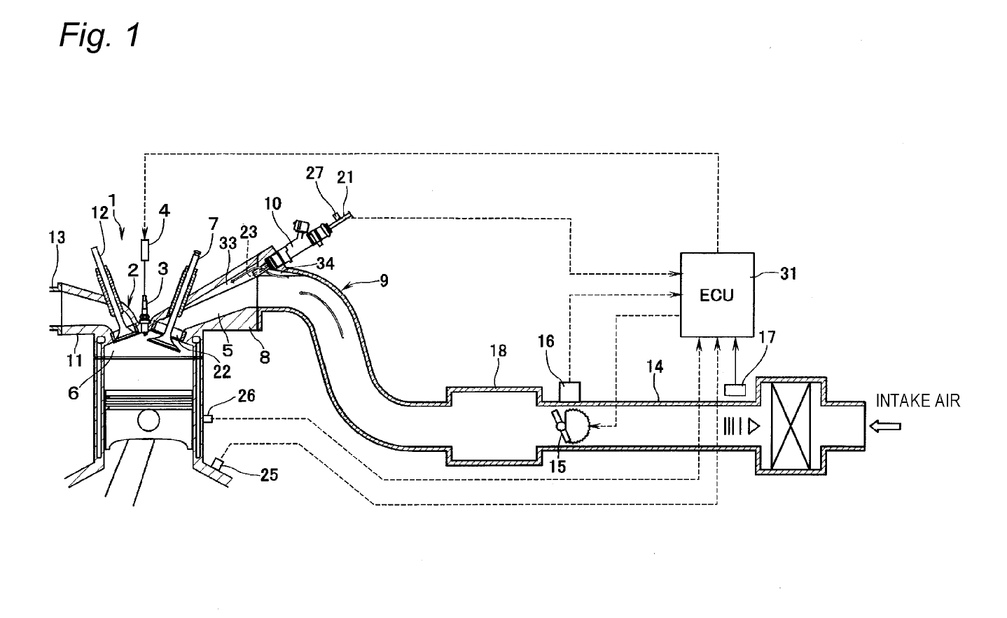

An internal combustion engine of the invention will be described by reference to FIGS. 1 to 6.

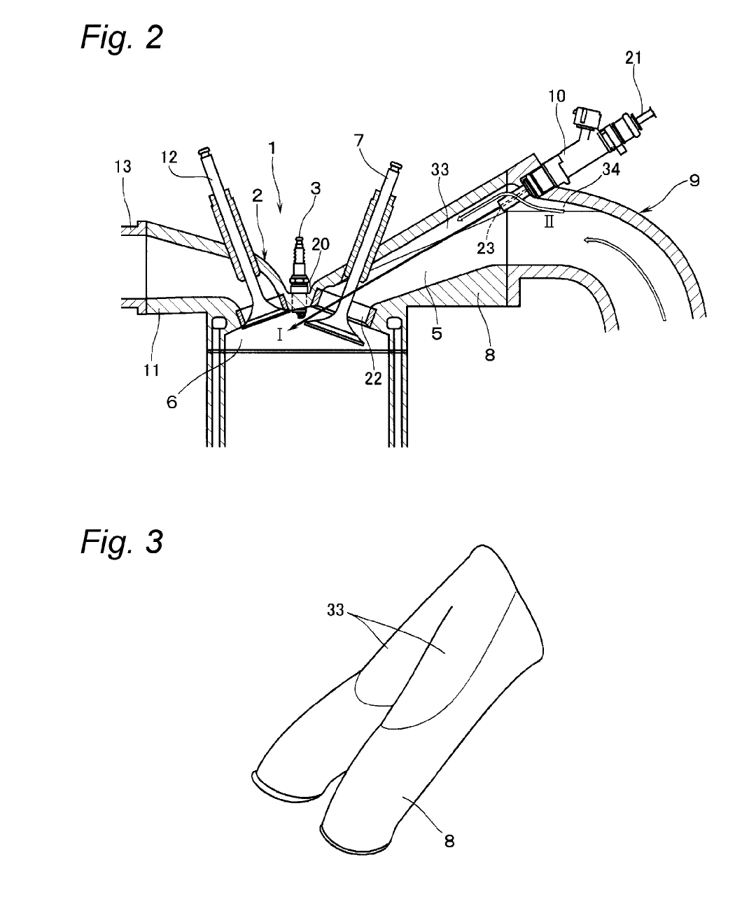

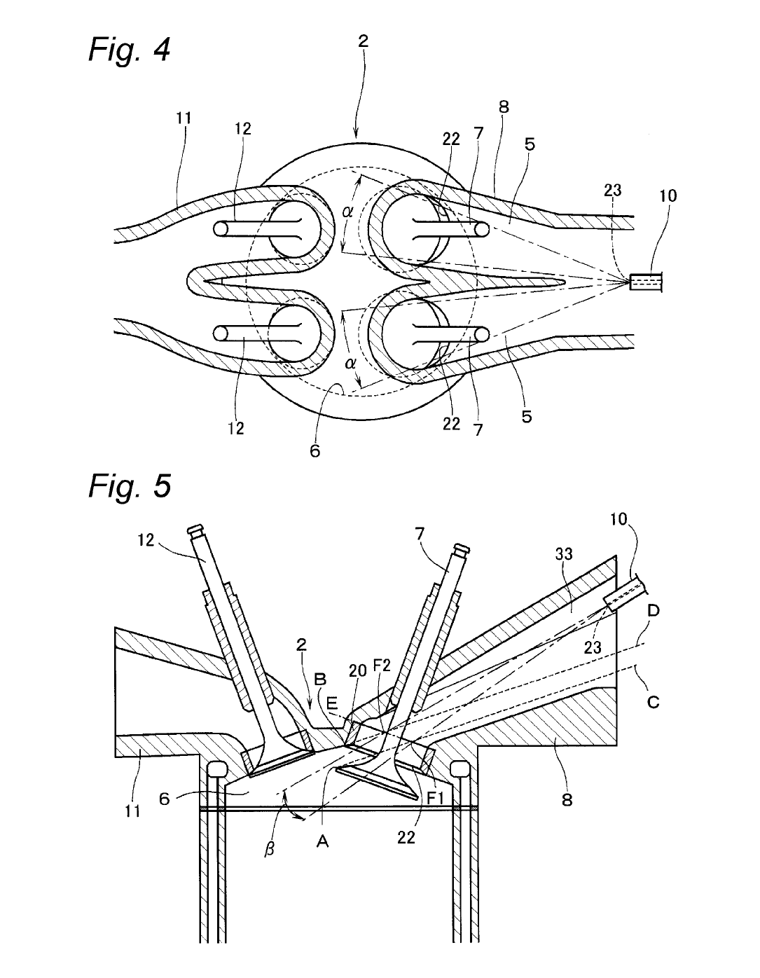

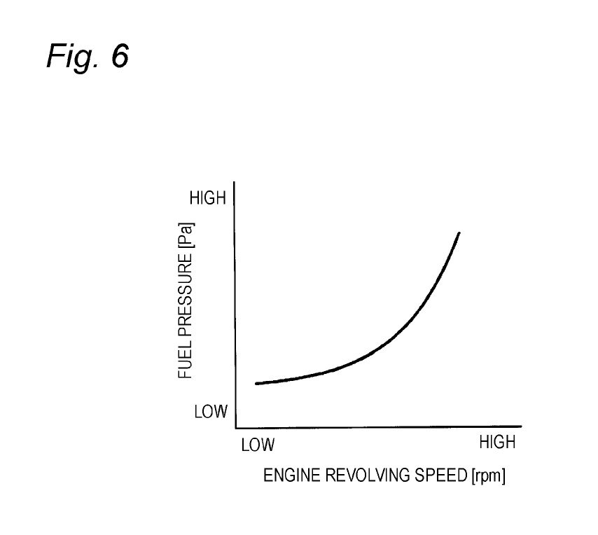

FIG. 1 is a schematic block diagram showing the whole of an internal combustion engine according to an embodiment of the invention. FIG. 2 is a specific configuration of the surroundings of an inlet port. FIG. 3 shows an external appearance of the inlet port in a perspective view. FIG. 4 shows how fuel spreads by use of a top plan view of the surroundings of the inlet port. FIG. 5 also shows how fuel spreads by use of a side view of the surroundings of the inlet port. FIG. 6 shows a relation between a revolving speed of the engine and a fuel pressure.

As shown in FIGS. 1 and 2, a spark plug 3 is mounted in a cylinder head 2 of an engine main body 1 (hereinafter, referred to as an engine) which is an internal combustion engine for each cylinder. An ignition coil 4 is connected to the spark plug 3 and outputs a high voltage thereto. Inlet ports 8 are formed in the cylinder head 2 for each cylinder and constitute an air intake passage 5. An inlet valve 7 is provided in an air intake passage 5 defined in the inlet port 8 at an end situated to face a combustion chamber 6. The inlet valve 7 is operated to be opened and closed while following the operation of a camshaft (not shown) which rotates as the engine rotates so as to open and close an inlet opening 22 defined between the air intake passage 5 and the combustion chamber 6. When the inlet opening 22 is opened and closed, a communication between the air intake passage 5 and the combustion chamber 6 is established and cut off, respectively.

Ends of branch pipes of an inlet manifold 9 are connected to the respective inlet ports 8, and air intake passages in the branch pipes of the inlet manifold 9 communicate with the corresponding inlet ports 8. The air intake passages in the branch pipes of the inlet manifold 9 extend from a lower level to communicate with the air intake passages 5 of the inlet ports 8. An electromagnetic fuel injection valve (injector) 10 is mounted in each branch pipe of the inlet manifold 9. The injector 10 is disposed so that a fuel injection port 23 of the injector 10 is directed towards the inlet openings 22 to inject fuel into the air intake passages 5 in the inlet ports 8. Fuel is supplied from a fuel tank (not shown) to the injector 10 via a fuel pipe 21.

Exhaust ports 11 are formed in the cylinder head 2 for each cylinder. An exhaust valve 12 is provided in each of exhaust gas discharge passages of the exhaust ports 11 at an end situated to face the combustion chamber 6. The exhaust valve 12 is operated to be opened and closed while following the operation of a camshaft (not shown) which rotates as the engine rotates so as to establish and cut off a communication between the exhaust gas discharge passage of the exhaust port 11 and the combustion chamber 6. Ends of branch pipes of an exhaust manifold 13 are connected to the exhaust ports 11 so as to establish a communication between the exhaust ports 11 and the exhaust manifold 13.

The engine having the configuration described above is generally known, and hence, a detailed description of the configuration of the engine will be omitted here.

An air intake pipe 14 is connected to an upstream side of the inlet manifold 9. An electromagnetic throttle valve 15 is mounted in the air intake pipe 14. A throttle position sensor 16 is provided on the air intake pipe 14 for detection of a position or opening angle of the throttle valve 15. The throttle valve 15 is operated in accordance with an amount by which an accelerator pedal is depressed.

An airflow sensor 17 is provided upstream of the throttle valve 15 for metering an intake air amount. An airflow sensor of Karman's vortex type or hot-film type is used as the airflow sensor 17. A surge tank 18 is provided along the air intake pipe 14 between the inlet manifold 9 and the throttle valve 15.

The engine 1 includes a crank angle sensor 25 which detects a crank angle to obtain an engine revolving speed (Ne) and a coolant temperature sensor 26 which detects a coolant temperature. Additionally, a fuel pressure sensor 27 is provided on the fuel pipe 21 for detecting the pressure of fuel supplied to the injector 10.

An ECU (Electronic Control Unit) 31 includes an input/output unit, a storage unit, a central processing unit (CPU), a timer counter and the like. The ECU 31 performs an overall control of the engine 1. A ROM, RAM and the like are used as the storage unit.

The sensors described above such as the throttle position sensor 16, the airflow sensor 17, the crank angle sensor 25, the coolant temperature sensor 26 and the fuel pressure sensor 27 are connected to an input side of the ECU 31, so that information detected by these sensors is inputted into the ECU 31. In addition, information on lift amount and lift timing of the inlet valves 7 and the exhaust valves 12 is inputted or stored in the ECU 31.

On the other hand, the output devices described above such as the ignition coils 4, the throttle valve 15 and driving devices of the injectors 10 are connected to an output side of the ECU 31. The ECU 31 calculates fuel injection amount, fuel injection period, fuel injection timing, ignition timing and operating conditions (valve operating conditions) of the inlet valves 7 and the exhaust valves 12 based on information detected and sent from the respective sensors and outputs them to the output devices.

An air-fuel ratio is set to an appropriate target air-fuel ratio based on the information detected and sent from the sensors. Then, an amount of fuel according to the target air-fuel ratio is injected from the injector 10 at an appropriate timing. The throttle valve 15 is adjusted to an appropriate position or opening angle, and a spark ignition is implemented by the spark plugs 3 at appropriate timings.

In the engine 1 of this embodiment, fuel is injected from the injectors 10 not only during an intake stroke but also during an exhaust stroke. In the event that the inlet valve 7 is opened when fuel injected reaches the vicinity of the inlet valve 7, the injection is defined as an intake stroke injection, whereas in the event that the inlet valve 7 has not yet been opened when fuel injected reaches the vicinity of the inlet valve 7, the injection is defined as an exhaust stroke injection. In reality, there exists a time lag from the issuance of a command to drive the injector 10 to the arrival of injected fuel at the vicinity of the inlet valve 7 due to a delay in opening of an injector needle valve or delay in delivery of fuel from the injector 10 to the inlet valve 7. Therefore, there may be a situation in which a command to drive the injector 10 for intake stroke injection is issued during an exhaust stroke.

By injecting fuel during an intake stroke in which the inlet valve 7 is opened, the adhesion of fuel to the air intake passage 5 or a valve seat portion of the inlet valve 7 is suppressed so that the vaporization latent heat of fuel can be made use of in cooling intake air. Because of this, not only is the temperature of an air-fuel mixture reduced so as to suppress the occurrence of knocking, but also the density of air is increased so as to increase the amount of air taken in when the engine is run at full load. Thus, even with the port injection, the cooling effect of the intake air can be improved at a maximum.

By injecting fuel from the injector 10 during an exhaust stroke, an air-fuel mixture can be obtained in which fuel and air are mixed together to a sufficient homogenized level in the interior of the air intake passage 5. The injector 10 is provided in the branch pipe connecting to the inlet ports 8, and therefore, the injector 10 is never exposed to combustion gases of high temperature and high pressure. Thus, a simple mounting construction can be adopted which does not have to secure the resistance to heat and pressure. Additionally, it is unnecessary to inject fuel at a high pressure, therefore it is possible to reduce the influence of power loss in the fuel pump on the performance of the engine to a low level.

As shown in FIG. 2, the inlet port 8 and the inlet opening 22 are connected by a cylindrical portion 20 (a throat portion). During an intake stroke, fuel is injected from the injector 10 to pass through the cylindrical portion 20 between a seat formed on the cylindrical portion 20 at a side facing the inlet opening 22 and the valve seat portion of the inlet valve 7 so as to be directed towards the interior of the combustion chamber 6, that is, towards a central portion of the inlet opening 22 when the inlet valve 7 is lifted up to its maximum lift-up level.

Thus, fuel is injected from the injector 10 in a straight line towards the inlet opening 22 along an upper wall portion of the air intake passage 5, while intake air is introduced towards the inlet opening 22 from upstream of the fuel injection port 23 of the injector 10. The injecting direction of fuel and the introducing direction of intake air become parallel to each other. By adopting this configuration, a spray of fuel is never disturbed by the flow of intake air, and hence, the adhesion of fuel to an inner wall surface of the inlet port 8 or the intake air passage 5 is suppressed. Thus, the sprayed fuel is mixed with the introduced intake air, and the resulting air-fuel mixture flows into the combustion chamber 6 (in the interior of the cylinder).

The configuration of the inlet port 8 and the inlet manifold 9, which constitute the air intake passage 5, will be described specifically by reference to FIGS. 2 and 3.

The air intake passage 5 is formed so as to extend over the inlet port 8 and the inlet manifold 9. The upper wall portion is provided in the air intake passage 5 so as to extend in a straight line towards the inlet opening 22. The upper wall portion is made into a spray passage 33 through which fuel injected from the injector 10 flows. A main body of the injector 10 is disposed in a portion of the spray passage 33 which is positioned in the inlet manifold 9 or the inlet port 8.

The fuel injection port 23 of the injector 10 is directed towards the inlet opening 22 and faces the air inlet passage 5 in the inlet port 8. A guide portion 34 is formed in the air inlet passage 5 so as to guide to introduce intake air into the spray passage 33. The guide portion 34 is formed to extend in the inlet manifold 9 and the inlet port 8 so as to introduce intake air from a portion of the inlet manifold 9 into the spray passage 33. Thus, intake air is introduced from the portion situated upstream of the fuel injection port 23 of the injector 10 and is injected towards the inlet opening 22.

By adopting this configuration, fuel is injected into the spray passage 33 from the fuel injection port 23 of the injector 10 (as indicated by an arrow I in FIG. 2), and intake air is introduced from upstream of the fuel injection port 23 by the guide portion 34. Because of this, the intake air is straightened in the spray passage 33 and is introduced parallel to the injecting direction of fuel (as indicated by an arrow II in FIG. 2) from upstream of fuel. Thus, even with the inlet manifold 9 which is configured so that air is supplied from downwards, the spray of fuel is never disturbed by the flow of intake air.

Consequently, fuel can be injected towards the combustion chamber 6 (the interior of the cylinder) in an ensured fashion. Thus, even in the event that a spray of fuel is carried away by a flow of intake air in an intermediate to high engine revolving speed range of the engine 1 where the flow rate of intake air becomes fast, the adhesion of fuel to the upper wall of the inlet port 8 (the air intake passage 5) is reduced largely, thereby making it possible to supply as much fuel injected as possible into the combustion chamber 6.

The fuel injection port 23 is set so that fuel is injected from the injector 10 so as to spread into a predetermined range relative to the inlet opening 22. How fuel spreads will be described by reference to FIGS. 4 and 5. As shown in the figures, in the internal combustion engine of this embodiment, two inlet openings 22 and two inlet ports 8 are provided for each cylinder, and one injector 10 is provided in each branch pipe of the inlet manifold 9 so that fuel is injected from the injector 10 towards the two inlet ports 8 to which the branch pipe connects.

As shown in FIG. 4, when the cylinder is seen from thereabove, the fuel injection port 23 of the injector 10 is set so that fuel is injected therefrom into a range (indicated by long dashed short dashed line in FIG. 4) which spreads in a width of an inside of the inlet opening 22. It is desirable to secure an angle of, for example, 12 degrees or larger as an angle α at which fuel spreads.

As shown in FIG. 5, when the cylinder is seen from a lateral thereof, the fuel injection port 23 of the injector 10 is set so that fuel is injected therefrom into a range (indicated by long dashed short dashed line in FIG. 5) which spreads in a width defined in a side of the center of the cylinder from a valve shaft of the inlet valve 7 in a state where the inlet valve 7 is in a maximum lift-up level within the inside of the inlet opening 22. It is desirable to secure an angle of, for example, 6 degrees or larger as an angle β at which fuel spreads.

The spread of fuel when the cylinder is seen from the lateral thereof is defined as follows.

A position of the valve seat of the inlet valve 7 when the inlet valve 7 is lifted up to its maximum lift-up level is referred to as A. The position of the seat at the inlet opening 22 is referred to as B. A line which extends along a lower surface of the air intake passage 5 from the position A as an originating point is referred to as a line C (indicated by a dotted line in FIG. 5). A line (parallel to the line C) which extends along the lower surface of the air intake passage 5 from the position B as an originating point is referred to as a line D (indicated by a dotted line in FIG. 5). A boundary line between the inlet port 8 and the cylindrical portion 20 is referred to as E (indicated by an alternate long and short dash line in FIG. 5). A point of intersection between the line C and the boundary line E is referred to as F1, and a point of intersection between the line D and the boundary line E is referred to as F2. That is, the fuel injected from the injector 10 spreads, when viewed from the lateral of the cylinder, into the range defined between two intersection points F1 and F2, at which the line C which extends along a lower surface of the air intake passage from a valve seat of the inlet valve when the inlet valve is in the maximum lift-up level and the line D which extends along the lower surface of the air intake passage 5 from the seat at the inlet opening 22 respectively intersect with the boundary line E between the cylindrical portion 20 and the inlet port 8 at the air intake passage 5.

When the cylinder is seen from the lateral thereof, the fuel injection port 23 of the injector 10 is set so that fuel injected therefrom passes between the point of intersection F1 and the point of intersection F2 and spreads into a range (indicated by the long dashed short dashed line in FIG. 5) which ranges in width from the valve shaft of the inlet valve 7 when the inlet valve 7 is lifted up to its maximum lift-up level to the center of the cylinder within the inside of the inlet opening 22.

As shown in FIGS. 4 and 5, when the cylinder is seen from thereabove, the fuel injection port 23 of the injector 10 is set so that fuel is injected or sprayed therefrom into the range which spreads in width to the inside diameter of the inlet opening 22. In addition, when the cylinder is seen from the lateral thereof, the fuel injection port 23 of the injector 10 is set so that fuel is injected therefrom into the range which spreads narrower in width than the range as seen from thereabove within the inside diameter of the inlet opening 22. Therefore, fuel is injected or sprayed into something like a sectorial body which is wider as viewed from thereabove than as viewed from the side thereof. Additionally, the injecting direction of fuel is desirably set so that fuel injected passes through a range defined from the center of the inlet port 8 to near a bent portion of the lower surface (a boundary line with the cylindrical portion 20) of the inlet port 8.

Because of this, even in the event that a spray of fuel is carried away by a flow of intake air in the intermediate to high engine revolving speed range of the engine 1 where the flow rate of intake air becomes fast, the adhesion of fuel to the upper wall of the inlet port 8 (the air intake passage 5) can be prevented. Moreover, fuel is sprayed into something like the sectorial body which is wider as viewed from thereabove than as viewed from the side thereof. Therefore, the surface area (that is, the contact area with air) of the spray of fuel is ensured, and the spray of fuel can be mixed with intake air without any interruption, there being no fear that the exhaust emission performance of the engine 1 is deteriorated. Further, the complete penetration force of the spray of fuel does not become too strong, and hence, it is prevented that fuel adheres to a wall surface of the cylinder (a cylinder liner) to dilute engine oil.

In the case of fuel injected being set to spread narrow as viewed from thereabove, the resulting spray of fuel comes to have rod-like geometries, and the surface area (that is, the contact area with air) of the spray of fuel cannot be ensured, whereby the spray of fuel is prevented from being mixed with intake air. In addition, the complete penetration force of the spray of fuel becomes strong, whereby fuel is caused to adhere to the wall surface of the cylinder (the cylinder liner) to thereby dilute engine oil.

In this embodiment, the pressure (fuel pressure) of fuel injected from the injector 10 is set to become higher as the revolving speed of the engine 1 increases (a fuel pressure setting device). Namely, as shown in FIG. 6, the fuel pressure is set to become higher when the revolving speed of the engine 1 increases (or as the revolving speed of the engine 1 increases higher). By increasing the fuel pressure in that way, even in a high engine revolving speed range (a predetermined range of the engine revolving speed), the flow rate of the spray of fuel is increased, and it is more difficult for the spray of fuel to be carried away by the flow of intake air, thereby making it possible to reduce further the adhesion of fuel to the upper wall of the inlet port 8 (the air intake passage 5).

As has been described heretofore, in the engine 1 of this embodiment, the generation of knocking is suppressed by controlling accurately the fuel injecting conditions during the intake stroke to make use of the vaporization latent heat of fuel in cooling intake air without providing a direct injector in the cylinder head which injects fuel directly into the interior of the cylinder. In addition, the density of air is increased by cooling intake air so as to increase the amount of intake air when the engine is driven at full load. Thus, the engine performance can be enhanced. Additionally, even when the pressure in the inlet port is higher than the pressure in the exhaust port, unburned fuel is prevented from being drawn into the exhaust port when an exhaust stroke commences, thereby making it possible to prevent the discharge of unburned HC. Further, a flow of air-fuel mixture induced by fuel injected flows into the cylinder to cause a strong swirling flow therein, promoting the propagation of flame inside the cylinder, whereby good combustion can be attained.

Because of this, the performance of the engine that would be obtained when fuel is directly injected into the interior of the cylinder can be obtained or maintained by controlling accurately the fuel injecting conditions during the intake stroke without providing a direct injector in the cylinder head which injects fuel directly into the interior of the cylinder, thereby making it possible to obtain a high performance of the engine.

According to the invention, fuel is injected into the air intake passage by the intake stroke injection device during the intake stroke, so that fuel is caused to flow into the interior of the cylinder while the inlet valve is opened. Fuel is injected from the injector into the range which spreads in width to the inside of the inlet opening when viewed from thereabove and which spreads in width in the range defined from the valve shaft of the inlet valve when the inlet valve is lifted up to its maximum lift-up level to the center of the cylinder within the inside of the inlet opening when viewed from the side thereof. Thus, even in the event that the spray of fuel is carried away by the flow of intake air, the adhesion of fuel to the wall surface of the inlet port or the air intake passage. Hence, fuel injected can be mixed well with intake air, and the resulting air-fuel mixture flows into the interior of the cylinder.

The generation of knocking is suppressed by making use of the vaporization latent heat of fuel in cooling intake air and the density of air is increased by cooling intake air so as to increase the amount of intake air when the engine is run at full load without providing a direct injector in the cylinder head which injects fuel directly into the interior of the cylinder. Thus, the performance of the engine can be increased.

The performance of the engine that would be obtained when fuel is directly injected into the interior of the cylinder can be obtained or maintained by controlling accurately the fuel injecting conditions during the intake stroke without providing a direct injector in the cylinder head which injects fuel directly into the interior of the cylinder, thereby making it possible to obtain a high performance of the engine.

In addition, in this invention, fuel is injected from the injector into the sectorial body which spreads in width to the inside diameter of the inlet opening when viewed from thereabove and which spreads in width narrower when viewed from the side thereof than when viewed from thereabove. Thus, the surface area (the contact area with air) of the spray of fuel is ensured, and fuel is never prevented from being mixed with intake air.

The invention can be applied to the lower surface of the air intake passage having the wall surface which extends into the straight line towards the inlet opening.

In the invention, fuel is injected from the injector directly towards the inlet opening along the upper wall portion, and intake air is introduced towards the inlet opening from upstream of the fuel injection port of the injector.

In the invention, the flow rate of the spray of fuel is increased by increasing the fuel pressure even in the high engine revolving speed range in which the flow rate of intake air becomes fast. Thus, it is more difficult for the spray of fuel to be carried away by the flow of intake air, thereby making it possible to reduce further the adhesion of fuel to the upper wall of the inlet port.

Thus, with the internal combustion engine of the invention, the performance of the engine that would be obtained when fuel is directly injected into the interior of the cylinder can be obtained or maintained by controlling accurately the fuel injecting conditions during the intake stroke without providing a direct injector in the cylinder head which injects fuel directly into the interior of the cylinder, thereby making it possible to obtain a high performance of the engine.

The invention can be applied to the industrial field of internal combustion engines which can realize an improvement in performance by setting accurately the fuel injecting conditions into the air intake passage without providing a direct injector directly in the cylinder head which injects fuel directly into the interior (the combustion chamber) of the cylinder.

What is claimed is:

1. An internal combustion engine comprising:
a fuel injection unit including at least an injector which injects fuel from a fuel injection port into an air intake passage, an inlet opening communicating the air intake passage with an interior of a cylinder via a cylindrical portion, and an intake stroke injection device which causes the injector to inject fuel in an intake stroke; and
a controller which causes the intake stroke injection device to cause the injector to inject fuel in the intake stroke so that the fuel is introduced into the interior of the cylinder from the inlet opening so that an air-fuel mixture is formed in the interior of the cylinder, wherein
the fuel is injected from the injector into a range, which spreads in a width of an inside of the inlet opening when viewed from above of the cylinder, and which spreads in a width defined in a side of a center of the cylinder from a valve shaft in a state where the inlet valve is in a maximum lift-up level within the inside of the inlet opening when viewed from a lateral of the cylinder.

2. The internal combustion engine as set forth in claim 1, wherein
the fuel injected from the injector spreads, when viewed from the lateral of the cylinder, into a range defined between two intersection points, at which a line which extends along a lower surface of the air intake passage from a valve seat of the inlet valve when the inlet valve is in the maximum lift-up level and a line which extends along the lower surface of the air intake passage from a seat at the inlet opening respectively intersect with a boundary line between the cylindrical portion and the air intake passage.

3. The internal combustion engine as set forth in claim 2, wherein
the lower surface of the air intake passage has a wall surface which extends straight towards the inlet opening.

4. The internal combustion engine as set forth in claim 3, wherein
the air intake passage has an upper wall portion which extends straight towards the inlet opening,
the fuel injection port of the injector is disposed so that an injecting direction of the fuel is parallel to the upper wall portion therealong, and
intake air into the air intake passage is introduced towards the inlet opening from an opposite side to the inlet opening across the fuel injection port of the injector, so that the injecting direction of fuel and an introducing direction of intake air is parallel to each other.

5. The internal combustion engine as set forth in claim 4, comprising:
a fuel pressure setting device for setting a fuel pressure in accordance with a revolving speed and load of the internal combustion engine,
wherein the controller causes the fuel pressure setting device to increase the fuel pressure in a state in which the revolving speed of the internal combustion engine is in a predetermined range of the revolving speed.

6. The internal combustion engine as set forth in claim 1, wherein
the lower surface of the air intake passage has a wall surface which extends straight towards the inlet opening.

7. The internal combustion engine as set forth in claim 6, wherein
the air intake passage has an upper wall portion which extends straight towards the inlet opening,
the fuel injection port of the injector is disposed so that an injecting direction of the fuel is parallel to the upper wall portion therealong, and
intake air into the air intake passage is introduced towards the inlet opening from an opposite side to the inlet opening across the fuel injection port of the injector, so that the injecting direction of fuel and an introducing direction of intake air is parallel to each other.

8. The internal combustion engine as set forth in claim 7, comprising:
a fuel pressure setting device for setting a fuel pressure in accordance with a revolving speed and load of the internal combustion engine,
wherein the controller causes the fuel pressure setting device to increase the fuel pressure in a state in which the revolving speed of the internal combustion engine is in a predetermined range of the revolving speed.
